(19) United States
(12) Patent Application Publication
(10) Pub. No.: US 2025/0118861 A1
(43) Pub. Date: Apr. 10, 2025

(54) VENTILATION DEVICE FOR A BATTERY

(71) Applicant: NEWFREY LLC, New Britain, CT (US)

(72) Inventors: Bastian STAU, Giessen (DE); Stefan SCHNEIDER, Giessen (DE)

(21) Appl. No.: 18/989,118

(22) Filed: Dec. 20, 2024

Related U.S. Application Data
(63) Continuation of application No. PCT/EP2023/066989, filed on Jun. 22, 2023.

(30) Foreign Application Priority Data
Jun. 22, 2022 (EP) 22180335.6

(51) Int. Cl. H01M 50/30; H01M 10/48; H01M 50/308; H01M 50/325

(52) U.S. Cl. CPC H01M 50/394; H01M 10/486; H01M 50/308; H01M 50/325; H01M 2200/20

(57) ABSTRACT

Battery system comprising a battery casing with a vent opening and a ventilation device and ventilation device comprising a first membrane adapted to ensure pressure balance between the inside of the battery casing and its environment during normal operation conditions of the battery system and a second membrane adapted to ensure an emergency venting in case of technical defect within the battery system.

### CROSS-REFERENCE TO RELATED APPLICATIONS

This application is a continuation of PCT Application No. PCT/EP2023/066089, filed Jun. 22, 2023, which claims priority from European Patent Application No. 22180335.6, filed Jun. 22, 2022, the disclosures of which are incorporated herein by reference in their entirety.

### BACKGROUND OF THE INVENTION

The present invention relates to a ventilation device for a battery, and particularly to a venting device for a casing of a battery submodule, battery module or battery system that is configured for being integrated in that casing. More particularly, the present invention relates to a device for equalizing the internal pressure of a housing, in particular a battery housing of a motor vehicle, with the ambient pressure of the housing. Furthermore, the invention relates to a battery system comprising such ventilation device.

In housings (or casings) of battery systems, in particular high-voltage battery system, such as those used in motor vehicles, temperature and pressure changes result in pressure differences between the housing of the battery system and the environment.

These pressure differences must be balanced in normal operation. To provide thermal control of the enclosed components a thermal management system may be used to efficiently emit, discharge and/or dissipate heat generated within the casing. If such thermal management system is omitted or the heat drain from the casing is not sufficiently performed, an increase of the internal temperature can lead to abnormal reactions occurring therein.

In addition, there is a risk, especially in high-voltage battery systems with a large capacity, that one or more cells in the battery will fail due to overloading or other technical defects. This can result in large amounts of harmful gas, which must be discharged in a controlled manner. Thus, an emergency venting in case of technical defect within the battery has to be provided.

One can use two different devices for both functions, pressure compensation in normal operation and emergency venting in case of technical defects. However, two devices increase the weight of the assembly as well as the maintenance.

Document DE102017214754A1 discloses a device combining both functions. The device comprises a pressure equalization element. The pressure equalization element has an element body and a membrane arranged on the element body. The device comprises a connecting element for the airtight connection of the pressure compensation element to the housing. The element body rests airtight on the connecting element when there is an internal pressure which is lower than a limit pressure. Besides, the element body opens an aperture for exchanging gas when there is an internal pressure which is greater than the limit pressure.

US2021396324 discloses a ventilation component to be attached to a housing at a ventilation opening of the housing, comprising a gas-permeable membrane and a ventilation valve that includes an elastic body, and that is opened and closed by elastic deformation of the elastic body, and a structural member that supports the gas-permeable membrane and the ventilation valve. The structural member is arranged between a housing and a cap of the ventilation component.

EP3617570A1 is directed to a ventilation unit comprising a first ventilation body that permits gas to flow from an inside of a housing to an outside of the housing when internal pressure is higher than external pressure, and a second ventilation body. The first and second ventilation bodies are connected to a structural support which is arranged inside a cavity of a housing of the ventilation unit.

US2018292020A1 discloses a pressure-compensation device for a housing with a gas opening covered by a gas-permeable membrane and a pressure-relief valve. The gas-permeable membrane and the pressure relief valve are both arranged within a lattice-like cage. The cage consists of an inner half 20, forming a housing and an outer half 21, forming a cap. The gas-permeable membrane and the pressure relief valve are both connected to the housing.

Such devices are adapted to deal with the pressure compensation function with the element body and the emergency venting with the membrane. However, a need still exists to improve such devices.

### SUMMARY OF THE INVENTION

It is an object of the present invention to provide a venting device which fulfils both functions (emergency degassing in the event of damage as well as differential pressure compensation in normal work environment) and which is robust, easy to manufacture, to mount and to maintain, with as less parts as possible. It is further an object of the present invention to provide a venting device which presents satisfactory performances in term of humidity management and service life.

Accordingly, the present disclosure is directed to a ventilation device for a battery with a battery casing having a vent opening according to claim 1 and to a battery system according to claim 14.

More particularly, the ventilation device comprises a housing, a cap cooperating with the housing, the cap extending above the housing, a first membrane adapted to ensure pressure balance between the inside of a battery system and its environment during normal operation conditions of the battery system. The device further comprises a second membrane adapted to ensure an emergency venting in case of technical defect within the battery system, wherein the cap comprises a first segment connected to the first membrane and a second segment connected to the second membrane. Thus, the cap is connected to both membranes, which renders the valve easy to mount and to maintain. The cap has thus two functions, protecting the inside of the housing and assembling the membranes.

In an embodiment, the first membrane is a breathable membrane. Thus, the membrane can easily ensure the pressure balance in a normal environment.

In an embodiment, the cap is ultrasonically welded to the first membrane. The ultrasonic welding ensures a robust fixation, is easy to realize. The welding is thus airtight.

In an embodiment, the second membrane is press-fitted between the housing and the cap. The press-fittings have high connection strength and anti-vibration. The assembly can be automated and is reliable and consistent. Besides, such connections have the ability to withstand thermal expansion during thermal cycling. In an embodiment, the second membrane is movable between an open position and a closed position, wherein the second membrane is automatically moved back to its closed position when a surplus pressure disappears.

In an embodiment, the cap is substantially circular with a central portion adapted to be covered by the first membrane and an outer annular portion adapted to be partly covered by the second membrane. The cap is integral but ensures different functions depending on the portion linked to the first or the second membrane. In an embodiment, the first membrane cover both the central portion and the outer annular portion. In other words, in an embodiment, the first membrane extends above the second membrane.

In an embodiment, the central portion comprises a plurality of ventilation holes. The ventilation holes are facing the first membrane to ensure a correct pressure balance.

In an embodiment, the second outer annular portion comprises a plurality of openings regularly distributed. The openings are curved. The openings are facing the second membrane.

In an embodiment, the cap comprises a rim covering at least partly an outer periphery of the housing. Thus, the cap is a protective cap and can surround the housing.

In an embodiment, the central portion comprises an edge extending longitudinally along a longitudinal axis from the inner surface, wherein the edge defines one or a plurality of cavities. The edge forms a reinforcing structure for the rigidity of the device.

In an embodiment, the first membrane is fixed to the edge. The edge forms a surface and the first membrane can easily be fixed to this surface.

In an embodiment, the ventilation device further comprises a sealing ring extending around the housing. The sealing ring is adapted to sealingly fix the ventilation device to the casing.

In an embodiment, the second membrane is annular. In an embodiment, the first membrane has the shape of a disc. In an embodiment, the first membrane extends substantially in the centre of the second membrane. Thus, a compact arrangement is provided.

In an embodiment, the first membrane is made of Polyethylene terephthalate (PET) or Polytetrafluoroethylene (PTFE) material. Such materials have high strength to weigh ratio and resistant to moisture.

In an embodiment, the second membrane is made of elastomer or thermoplastic elastomer material. Such materials are customizable in size, shape or flexibility.

In an embodiment, the lid and/or the cap and/or the housing is made of metal material. It can thus better resist high temperatures.

In an embodiment, the lid is adapted to be ejected automatically from the cap in the event of overpressure. In other words, the fixation of the lid to the cap is releasable.

In an embodiment, the second membrane is adapted to move from an open position to a closed position, so that gases can escape from the battery, but cannot subsequently migrate back into the battery housing. Since some of these gases are highly flammable, in some cases this helps to prevent a thermal runaway event. The second membrane is therefore reversible. The automatically motion from the open position to the closed position can occurs up to a certain temperature.

The present invention is also directed to a battery system comprising a battery casing with a vent opening and a ventilation device, wherein the ventilation device (and more particularly its housing) is inserted in the vent opening.

### BRIEF DESCRIPTION OF THE SEVERAL VIEWS OF THE DRAWING

A specific embodiment of the present invention will now be described, by way of example only and with reference to the accompanying drawings, of which:

FIG. 1 is a schematic perspective view of a battery system with a ventilation device according to the invention;

FIG. 2 is an exploded perspective view of the ventilation device of FIG. 1 according to a first embodiment;

FIG. 3 is a side view in section of the ventilation device of FIG. 2 in a mounted state;

FIG. 4 shows a perspective view of a ventilation device according to a second embodiment of the invention;

FIG. 5 shows a side view in section of the ventilation device of FIG. 4;

FIG. 6 shows an exploded perspective view of the ventilation device of FIG. 4;

FIG. 7 shows a perspective view of a ventilation device according to a third embodiment of the invention;

FIG. 8 shows a side view in section of the ventilation device of FIG. 7 without its housing;

FIG. 9 shows an exploded perspective view of the ventilation device of FIG. 7.

### DETAILED DESCRIPTION OF THE INVENTION

On the different figures, the same reference signs designate identical or similar elements.

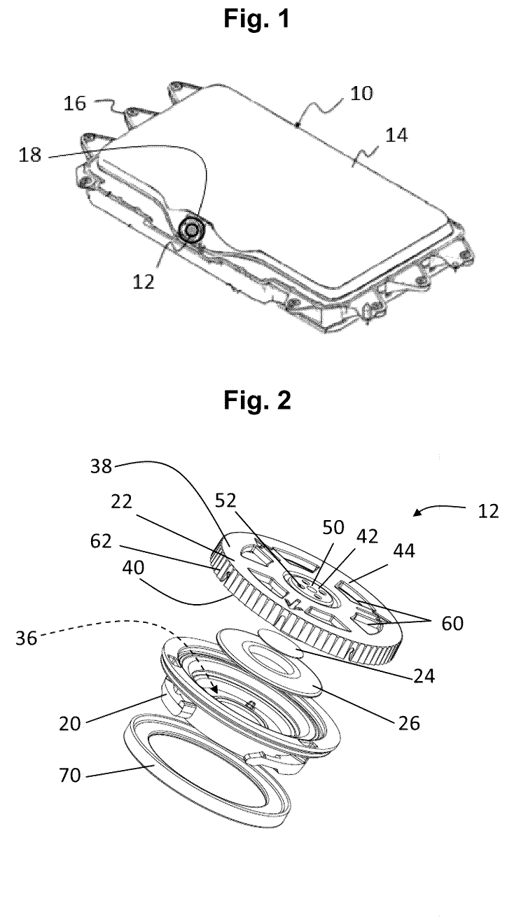

FIG. 1 illustrates a schematic perspective view of a battery system 10 with a ventilation device 12. The shape of the battery system 10 and the arrangement in FIG. 1 is for illustration purpose. The battery system 10 comprises a casing 14. In the context of the present application, a battery system 10 is to be understood as one of a battery submodule, a battery module and a battery pack. Hence the battery casing 14 is to be understood to be a casing of one of a battery submodule, a battery module and a battery system. The casing 14 may consist of a metal alloy and/or a plastic material. The battery system 10 may comprise a plurality of attachment portions 16 for mounting the battery system to a fixing structure, for example an electric vehicle. The casing 14 comprises a vent opening 18. More particularly, the casing may comprise 2 or 3 vent openings. Eventually more than 3 vent openings may also be provided.

The vent opening 18 is adapted to receive the ventilation device 12, 12′, 12″. A bayonet mount can be used to connect the ventilation device 12, 12′, 12″ to the vent opening 18.

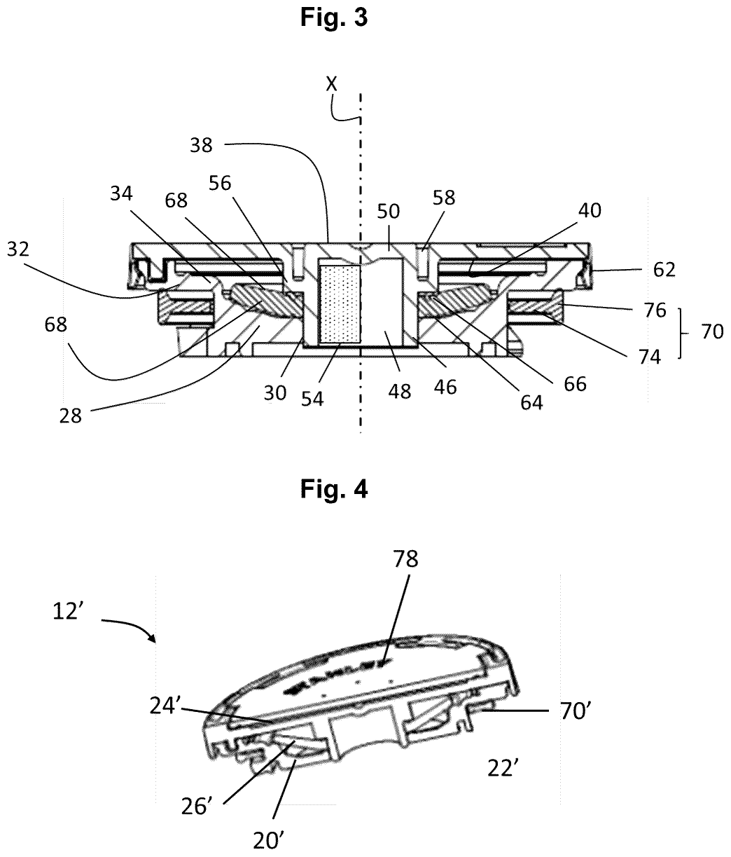

A first embodiment of the ventilation device 12 is shown in FIG. 2 and FIG. 3. The ventilation device 12 may be configured to be attached to the casing 14 for covering and/or overlapping the vent opening. Alternatively, the ventilation device 12 may be configured to be inserted into the vent opening 18.

As depicted in FIG. 2, the ventilation device 12 comprises a housing 20, a cap 22, a first membrane 24 and a second membrane 26. The cap 22 comprises a first segment connected to the first membrane 24 and a second segment connected to the second membrane 26.

When the ventilation device 12 is configured to be inserted into the vent opening 18, the housing 20 of the ventilation device 12 cooperates with the vent opening 18. The housing 20 is for instance substantially annular around a longitudinal axis. However, alternatively, the shape of the housing 20 may be rectangular or oval. Actually, the shape of the housing 20 is complimentary with the shape of the vent opening 18. The housing 20 for example comprises a first flange 28 (see for instance FIG. 3) delimiting a central opening 30, and a second flange 32 radially outwardly extending from the first flange 28. A housing bent portion (housing elbow) 34 is arranged between the first and the second flange 28, 32 and connects said flanges 28, 32. The second flange 32 may have a substantially flat surface, wherein the first flange 28 may be inclined. The first flange 28 has for instance a reduced diameter with regard to the second flange. The first flange 28 may be provided with first flange openings 36. The housing 20 is adapted to cooperate with the cap 22 in a mounted state of the ventilation device 12.

The cap 22 is for instance a protective cap. The cap 22 comprises an outer surface 38 and an inner surface 40. The inner surface 38 faces the housing 20, wherein the outer surface 38 is opposite the inner surface 36. The cap 22 has a substantially circular shape. The cap has a first portion 42 which forms a central portion and a second portion 44 arranged around the first portion. The cap 22 is for instance integral. The first position 42 comprises an edge 46 which extends longitudinally from the inner surface 40 such as to delimit a cavity 48. For instance, the edge 46 delimit a cavity 48 having a circular cross-section. The bottom 50 of the cavity 48 comprises at least one, but for instance a plurality of ventilation holes 52. A supporting structure 54 may extend between the edge 46 such as to delimit a plurality of sub-cavities and to render the cap 22 more rigid. The second portion 44 of the cap is an outer annular portion. The edge 46 is connected to the second portion 44 by a cap bent portion 56 (cap elbow), such that a groove 58 is formed at the outer surface 38 of the cap 22, the groove 58 separating the first portion 42 and the second portion 44. The second portion 44 may comprise a plurality of openings 60 regularly distributed, for instance around a longitudinal axis X. The cap 22 also comprises a rim 62 extending at its outer periphery from the inner surface 40. The rim 62 is adapted to cover at least partly an outer periphery of the housing 20. More particularly, as visible in FIG. 3, the rim 62 may cover longitudinally the second flange 32 of the housing. The cap substantially covers or extends above the housing, thus protecting the housing.

The first membrane 24 is a breathable membrane. The first membrane 24 is for instance made of Polyethylene terephthalate (PET) or Polytetrafluoroethylene (PTFE) material. The first membrane 24 has a disc shape.

The second membrane 26 has an annular shape. The second membrane is for instance made of elastomer or thermoplastic elastomer.

The first membrane 24 is connected to the first portion 42 of the cap 22. The first portion 42 forms the first segment. More particularly, the first membrane 24 is airtight ultrasonically welded to the cap 22. For instance, the first membrane 24 is welded to the edge 46 of the cap 22, such that it covers the cavity 48 (or all the sub-cavities). The edge 46 comprises an edge surface substantially parallel to the inner surface 40 of the cap and the first membrane 24 is welded to the edge surface. Thus, the first membrane 24 is at a non-zero distance from the ventilation holes 52 and faces said ventilation holes 52. The diameter of the first membrane 24 corresponds substantially to the diameter of the edge 46 which delimits the cavity 48. Thus, the first membrane 24 covers entirely the cavity 48. As mentioned above, the supporting structure 54 may be arranged within the cavity. The supporting structure 54 may also support the first membrane 24. Eventually the first membrane 24 may be welded to the supporting structure 54.

The second membrane 26 is connected to the second portion 44 of the cap. The second portion forms the second segment. The second membrane 26 has an annular shape, such that in the mounted state of the ventilation device 12, it surrounds the edge 46. More particularly, the surface defining the inner circle of the annular-shaped second membrane faces the edge 46 and is arranged under the cap bent portion 56. The second membrane is press-fitted between the cap 22 and the housing 20. More particularly the cap bent portion 56 comprises a cap edge 64, and the first flange 28 of the housing comprises a housing edge 66, facing the cap edge 64 in the mounted state of the ventilation device. The second membrane 26 is press-fitted between the cap edge 64 and the housing edge 66. For instance, a segment of the second membrane in the vicinity of the inner circle of the annular-shaped second membrane is press-fitted between the edges 64, 66. An outer periphery 68 of the second membrane forms a free end, such that the second membrane 26 (and more particularly a segment in the vicinity of the free end) can freely move with regard to the cap and the housing. The free end or outer periphery 68 is movable between a rest or closed position, in which it rests against a surface of the housing 20 and an open position, for instance to ensure an emergency venting in case of technical defect within the battery system 10. The outer periphery 68 rests against the first flange 28. More particularly, the outer periphery 68 rests against a curved portion of the first flange. In other words, the first flange 68 comprises a protrusion which has a particular radius of curvature and the outer periphery of the membrane contact and rests against this protrusion. The second membrane may have a surface having a low roughness. More particularly the average roughness depth Rz is of importance. The average roughness depth Rz is defined by the mean value of the individual roughness depths of five consecutive individual measuring sections in the roughness profile. The surface of the second membrane has for instance a porosity of less than 0.6 micrometres, and in particular of less than 0.4 micrometres. The low roughness (or porosity) of the surface allows to increase the performance of the second membrane and in particular to reduce the amount of humidity passing through the membrane when said second membrane is in the closed position.

The second membrane 26 faces for instance the first flange openings 36. The portion of the second membrane which is movable faces the second portion 44 of the cap, and more particularly may face at least partly the plurality of second portion openings 60. The outer periphery 68 of the second membrane is closer to the first membrane than the inner periphery of the second membrane. In other words, the second membrane is not flat but forms a slope or a curved shape, with its outer periphery closer to the outer portion 38 of the cap than its inner periphery when measured according to the longitudinal axis. Seen from the upper side of the ventilation device (or from the outer portion side of the cap), the second membrane 26 may have a concave shape. Sais shape of the second membrane allows reducing the amount of humidity passing through the membrane when said second membrane is in the closed position.

The second membrane can automatically move from an open position to a closed position up to a certain temperature, so that gases can escape from the battery, but cannot subsequently migrate back into the battery housing. In other words, to allows gases from inside the battery housing or battery casing to be evacuated outside, the second membrane can move from the closed position (where the free end of the second membrane does not contact the housing 20) to an open position (the free end is then at distance from the housing 20, allowing evacuation of gases from inside the battery casing to the outside). Then, after the release of the gases, when the pressure inside the battery casing decrease under a certain value, the second membrane can automatically go back into its closed position. Since some of these gases are highly flammable, in some cases this helps to prevent a thermal runaway event. The second membrane is therefore reversible. The second membrane 26 forms a diaphragm secured at one side only and being actuated by fluid pressure. The second membrane opens on surplus pressure on the inside of the battery casing and closes when the surplus pressure disappears.

The ventilation device 12, notably when configured to be inserted into the vent opening 18, further comprises a sealing ring 70 extending around the housing 20. For instance, the housing 20 comprises on its external lateral surface a recess 72 adapted to receive the sealing ring 70. The sealing ring 70 is for instance made of elastomer or thermoplastic elastomer. The sealing ring 70 is for instance an O-ring. The sealing ring 70 is arranged below the second flange. It has a flat surface 74 substantially parallel to the second flange, and a lateral surface 76, orthogonal to the flat surface. The sealing ring 70 is such that the ventilation device 12 may be connected to the casing 14 in an airtight and watertight manner. The vent opening 16 has a shape complimentary to the shape of the housing 20 with the sealing ring 70.

In a mounted state of the ventilation device 12, the cap 22 cooperates with the housing 20 for instance with a snap fit connection. For example, as depicted in FIG. 3 the inner surface of the rim 62 is snap fitted with a portion of the housing 20. More particularly the rim is in a snap-fit connection with the lateral surface of the second flange 32 of the housing 20. In other embodiments, cap and housing may be press-fitted or glued or welded. The second membrane 26, as mentioned above is sandwiched between the cap 22 and the housing 20, wherein the first membrane 24 is fixed to the cap only. The inner diameter of the second membrane 26 is greater than the diameter of the first membrane 24.

The cap, 22, housing 20, first membrane 22 and second membrane 24 are mounted together such as to form the ventilation device 12. For example, all these parts have a substantially circular outer shape and their central axis (corresponding to the longitudinal axis X) coincide in a mounted state of the ventilation device. The ventilation device 12 is mounted in the vent opening of the battery system such that the first membrane is directed toward the interior of the casing, and the outer surface of the cap extends outside. The second membrane is arranged between the cap and the housing and is moved in the open position in case of technical defect for emergency venting. As depicted in FIG. 3, the first membrane may be substantially below the housing, wherein the second membrane is arranged between the housing and the cap.

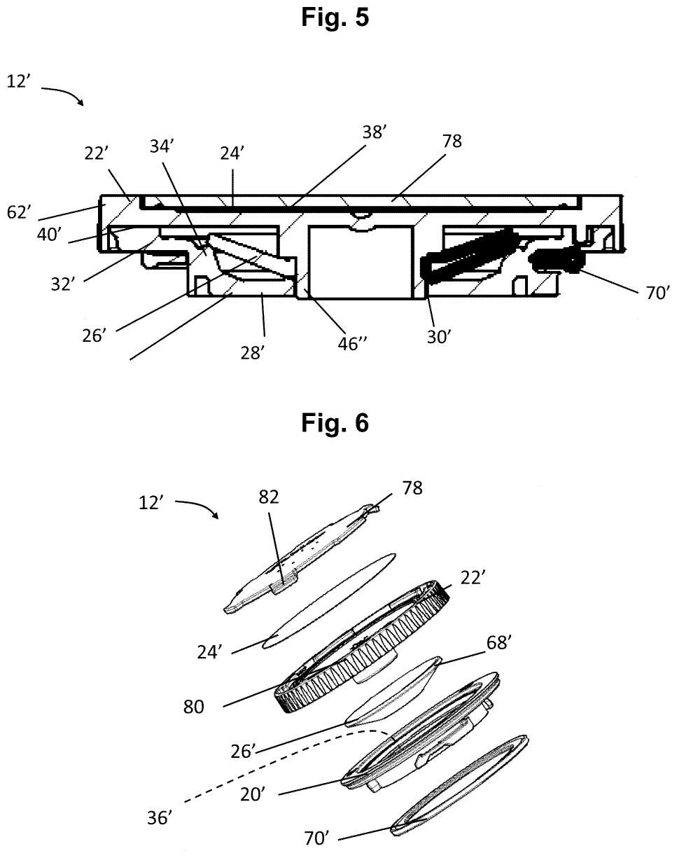

A second embodiment of the ventilation device 12′ according to the invention is shown in FIG. 4, FIG. 5, and FIG. 6. As described in more details below, the main difference between the first embodiment as disclosed in FIG. 2 and FIG. 3 and the second embodiment as seen in FIG. 4 to FIG. 6 is the size and the position of the first membrane 24′. Whereas the first membrane 24 in the first embodiment is arranged at a bottom side of the cap, the first membrane 24′ in the second embodiment is arranged at the upper side or outer surface 38′ of the cap and thus the surface of the first membrane can be increased without increasing the size of the ventilation device. By increasing the surface area of the first membrane 24′, the air flow rate can also be increased thus increasing the performance of the ventilation device.

As seen in FIGS. 4 to 6, the ventilation device 12′ comprises a housing 20′, a cap 22′, a first membrane 24′ and a second membrane 26′. The ventilation device 12′ further comprises a lid 78.

The housing 20′ of the ventilation device 12′ is adapted to cooperate with the vent opening 18. The housing 20′ is for instance substantially annular around a longitudinal axis. However, alternatively, the shape of the housing 20′ may be rectangular or oval. Actually, the shape of the housing 20′ is complimentary with the shape of the vent opening 18. The housing 20′ for instance is similar to the housing 20 of the first embodiment. The housing 20′ comprises a first flange 28′ delimiting a central opening 30′, and a second flange 32′ radially outwardly extending from the first flange 28′. A housing bent portion (housing elbow) 34′ is arranged between the first and the second flange 28′, 32′ and connects said flanges 28′, 32′. The second flange 32′ may have a substantially flat surface, wherein the first flange 28′ may be inclined. The first flange 28′ has for instance a reduced diameter with regard to the second flange 32′. The first flange 28′ may be provided with first flange openings 36′. The housing 20′ is adapted to cooperate with the cap 22′ in a mounted state of the ventilation device 12′.

The cap 22′ comprises an outer surface 38′ and an inner surface 40′. The inner surface 38′ faces the housing 20′, wherein the outer surface 38′ is opposite the inner surface 36′. The cap 22′ has a substantially circular shape. The cap 22′ has a first portion which forms a central portion and a second portion arranged around the first portion. The cap 22′ is for instance integral. The first portion may comprise an edge 46′ which extends longitudinally from the inner surface 40 such as to delimit a cavity 48. For instance, the edge 46′ may delimit a cavity having a circular cross-section. The cap 22′ comprises a plurality of ventilation holes 52. The ventilation holes are for instance provided on the first portion. The second portion of the cap 22′ is an outer annular portion. The second portion may comprise a plurality of openings regularly distributed, for instance around a longitudinal axis X.

Alternatively, the openings may be irregularly distributed. The cap 22′ also comprises a rim 62′ extending at its outer periphery from the inner surface. The rim 62′ is adapted to cover at least partly an outer periphery of the housing 20′. More particularly, as visible in FIG. 5, the rim 62′ may cover longitudinally the second flange 32′ of the housing. The cap substantially covers or extends above the housing, thus protecting the housing.

Between the rim 62′ and the second portion, slots or notches 80 may be provided to cooperate with tongues or latches 82 provided on the lid 78. The lid 78 cooperates with the cap 22′ through a snap fit connection. Alternatively, the lid may also be glued or welded or press-fitted to the cap 22′. The lid 78 comprises a plurality of hole for allowing air flow through the first membrane 24′. The plurality of hole is for instance arranged in the middle of the lid 78, as visible in FIG. 4. However, alternatively the plurality of hole may be distributed on the entire surface of the lid 78. In another alternative embodiment, the lid may be made in a porous material. In case of overpressure, the lid can be automatically released or ejected from the cap. The snap-fit connection between the lid 78 and the cap 22′ is such that it is releasable in case of overpressure. The snap fit may be dimensioned such that the lid is released from a certain predetermined pressure. The lid may be made in plastic or metal material. Similarly, the housing and/or the cap may be made in plastic material or in metal material.

The first membrane 24′ is connected to a first segment of the cap. More particularly, the first membrane 24′ is arranged between the lid and the cap. More particularly the first membrane 24′ can be fixed to the cap through ultrasonic welding or fixed to the cap 22′ through a press-fit connection between the cap 22′ and the lid 78. The first membrane extends on the upper side of the cap 22′. The first membrane extends on the outer portion 38′ of the cap. The first membrane 24′ extends entire surface area of central portion and the outer annular portion. The upper side of the cap 224 is the surface opposite the lower side of the cap 22′. The lower side of the cap 22′ is adapted to face the vent opening. More particularly the first membrane 24′ may extends up to the rim 62′, or substantially up to the rim 62′. The rim 62′ form a recess in which the first membrane 24′ is arranged. The notches 80 remain free for their connection to the lid 78. Thus, the first membrane 24′ faces said ventilation holes. The first membrane may also face the plurality of openings 60′, which can act as ventilation holes. The diameter of the first membrane 24′ corresponds substantially to the diameter of the second portion 44′. The first membrane 24′ is a breathable membrane. The first membrane 24′ is for instance made of Polyethylene terephthalate (PET) or Polytetrafluoroethylene (PTFE) material. The first membrane 24 has a disc shape.

The cap 22′ cooperates with the housing 20′ for instance with a snap fit connection. The cap 22′ extends entirely above the housing, such as to protect it. In other words, the cap covers the housing. For example, as depicted in FIG. 5 the inner surface of the rim 62′ is snap fitted with a portion of the housing 20′. More particularly the rim is in a snap-fit connection with the lateral surface of the second flange 32′ of the housing 20′. In other embodiments, cap and housing may be press-fitted or glued or welded.

The second membrane 26′ has an annular shape. The second membrane is for instance made of elastomer or thermoplastic elastomer. The second membrane 26′ is connected to the second segment which is formed by the second portion of the cap. The second membrane 26′ has an annular shape, such that in the mounted state of the ventilation device 12′, it surrounds the edge 46′. More particularly, the surface defining the inner circle of the annular-shaped second membrane faces the edge 46′. The second membrane is press-fitted between the cap 22′ and an edge of the housing 20′. Thus, the second membrane 26′ is fixed to the cap 22′. For instance, a segment of the second membrane in the vicinity of the inner circle of the annular-shaped second membrane is press-fitted between edges of the cap 22′ and the housing 20′. An outer periphery 68′ of the second membrane forms a free end, such that the second membrane 26′ (and more particularly a segment in the vicinity of the free end) can freely move with regard to the cap and the housing. The free end or outer periphery 68′ is movable between a rest position, in which it rests against a surface of the housing 20 and an open position, for instance to ensure an emergency venting in case of technical defect within the battery system 10. The outer periphery 68′ rests against the first flange 28′. The second membrane 26′ faces for instance the first flange openings 36′. The portion of the second membrane which is movable faces the second portion of the cap, and more particularly may face at least partly the plurality of second portion openings. The outer periphery 68′ of the second membrane is closer to the first membrane than the inner periphery of the second membrane. In other words, the second membrane is not flat but forms a slope or a curved shape, with its outer periphery closer to the outer portion 38′ of the cap than its inner periphery when measured according to the longitudinal axis. Seen from the upper side of the ventilation device (or from the outer portion side), the second membrane may have a concave shape. This arrangement allows a better emergency venting. The second membrane may have a surface having a low roughness. More particularly the average roughness depth Rz is of importance. The average roughness depth Rz is defined by the mean value of the individual roughness depths of five consecutive individual measuring sections in the roughness profile. The surface of the second membrane has for instance a porosity of less than 0.6 micrometres, and in particular of less than 0.4 micrometres. The low roughness (or porosity) of the surface allows to increase the performance of the second membrane and in particular to reduce the amount of humidity passing through the membrane when said second membrane is in the closed position.

The first membrane 24′ extends entirely above the second membrane. In other words, the first membrane covers the second membrane.

The ventilation device 12′ may comprise a sealing ring 70′ extending around the housing 20′. For instance, the housing 20′ comprises on its external lateral surface a recess 72′ adapted to receive the sealing ring 70′. The sealing ring 70′ is for instance made of elastomer or thermoplastic elastomer. The sealing ring 70′ is for instance an O-ring. The sealing ring 70′ is arranged below the second flange 32′. It has a flat surface 74 substantially parallel to the second flange, and a lateral surface 76, orthogonal to the flat surface. The sealing ring 70′ is such that the ventilation device 12′ may be connected to the casing 14′ in an airtight and watertight manner.

The cap 22′, housing 20′, first membrane 22′, second membrane 24′ and lid 78 are mounted together such as to form the ventilation device 12′. For example, all these parts have a substantially circular outer shape and their central axis (corresponding to the longitudinal axis X) coincide in a mounted state of the ventilation device.

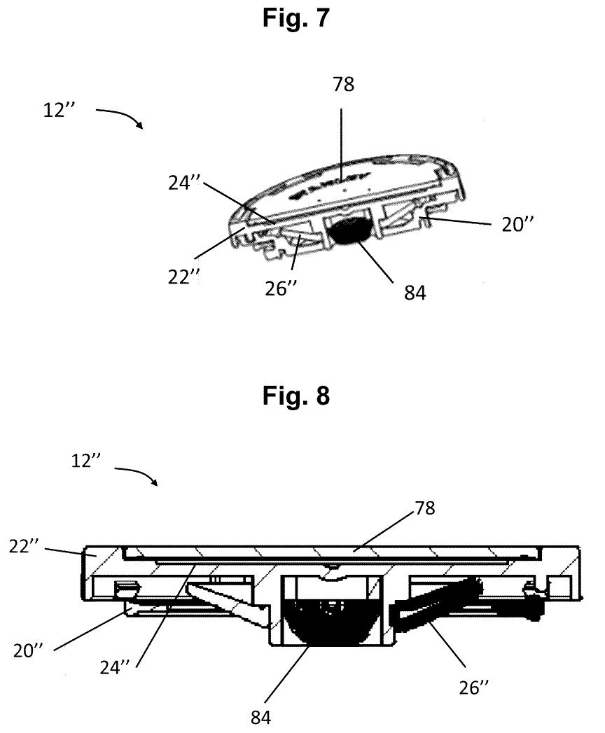

FIGS. 7 to 9 show the ventilation device 12″ according to a third embodiment. The ventilation device 12″ comprises a housing 20″, a cap 22″, a first membrane 24″, a second membrane 26″, a lid 78′ which are arranged in a similar or identical way than the housing 20′, cap 22′, first membrane 24′, second membrane 26′ and lid 78 of the second embodiment. The ventilation device 12″ further comprises a sensor 84. The sensor 84 can be a gas sensor, a humidity sensor, a pressure sensor, a temperature sensor, . . . , for instance for predictive diagnostic and predictive maintenance.

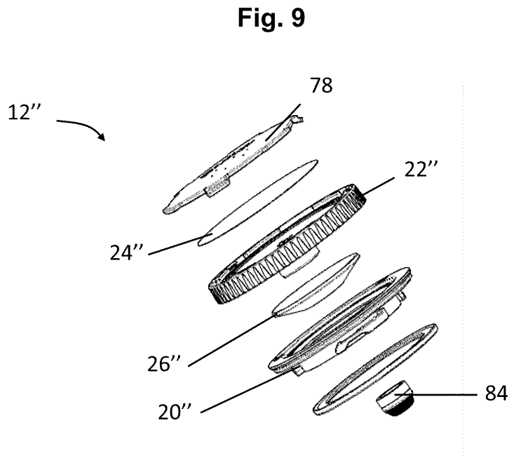

As depicted in FIG. 7, FIG. 8 and FIG. 9, the sensor may be arranged within the cavity formed by the cap 22″. More particularly, the sensor 84 may be arranged in the cavity 48″ delimited by the edge 46″ of the first portion 42″. More generally, the sensor 84 is arranged within the ventilation device such that it is able to collect the data needed. In the case of a gas sensor 84, the presence of the sensor in the cavity allows the presence of the sensor in a main air flow channel. Besides, the sensor does not protrude from the rest of the ventilation device (and in particular from the housing and the cap), as visible in FIG. 7 and in FIG. 8. Thus, the ventilation device 12″ remains compact. The sensor being arranged in the cavity formed by the cap is protected by the wall of the cavity. This reduces the risks of damage.

Said ventilation devices, when in a mounted state, is compact and allows, to fulfil the two functions needed in a battery system (pressure balance in a normal work environment and emergency venting in case of technical defect). These two functions are fulfilled with only few elements, i.e. the cap 22, the housing 20, the first and second membranes 24, 26 (and eventually the sealing ring 70). No further element is necessary. Besides, the arrangement of the first membrane 24 with regard to the second membrane 26 allows to realize a compact device. The position and shape of the second membrane (concave shape from the upper side) allows to decrease also the overall dimensions of the ventilation device. Besides, it reduces the humidity penetration within the casing. The ventilation device is particularly flat as well, such that it does not protrudes in a non-functional or non-homogeneous way. In a normal work environment, the first membrane balances the pressure between the interior of the casing and the outside environment. The ventilation holes allow a regular and easy ventilation and their position-at distance from the first membrane-decreases the risks of humidity entering the casing. For instance, in case of emergency venting, the second membrane opens with an intern pressure being between 0.05 and 0.15 bar.

Reference Numerals: battery system 10, ventilation device 12, 12′, 12″, casing 14, attachment portions 16, vent opening 18, housing 20, 20′, 20″, cap 22, 22′, 22″, first membrane 24, 24′, 24″, second membrane 26, 26′, first flange 28, 28′, central opening 30, 30′, second flange 32, 32′, housing bent portion 34, 34′, first flange openings 36, 36′, outer surface 38, 38′, an inner surface 40, 40′, first portion, 42, second portion 44, edge 46, cavity 48, bottom 50, ventilation holes 52, supporting structure 54, cap bent portion 56, groove 58, openings of the second portion 60, rim 62, cap edge 64, housing edge 66, outer periphery 68, sealing ring 70, recess 72, flat surface 74, lateral surface 76, lid 78, slots or notches 80, tongues or latches 82, sensor 84.

What is claimed is:

1. A ventilation device for a battery system including a battery casing having a vent opening, the ventilation device comprising:
a housing adapted to be attached to the battery casing,
a cap with an outer surface and an inner surface, wherein the inner surface faces the housing, and the cap cooperates with the housing and extends above the housing,
a first membrane adapted to ensure pressure balance between the inside of the casing and its environment during normal operation conditions of the battery system,
a second membrane adapted to ensure an emergency venting in case of technical defect within the battery system, and
the cap comprises a first segment connected to the first membrane and a second segment connected to the second membrane.

2. The ventilation device according to claim 1, wherein the first membrane is a breathable membrane.

3. The ventilation device according to claim 2, wherein the second membrane is press-fitted between the housing and the cap and wherein the second membrane comprises an annular shape with an inner periphery and an outer periphery, and the outer periphery is closer from the cap than the inner periphery.

4. The ventilation device according to claim 3, wherein the cap is circular with a central portion covered by the first membrane and an outer annular portion partly covered by the second membrane.

5. The ventilation device according to claim 4, wherein the central portion comprises a ventilation hole.

6. The ventilation device according to claim 5, wherein the outer annular portion comprises an opening.

7. The ventilation device according to claim 4, wherein the first membrane covers the central portion and the outer annular portion.

8. The ventilation device according to claim 1, wherein the cap comprises a rim.

9. The ventilation device according to claim 4, wherein the central portion comprises an edge extending longitudinally along a longitudinal axis (X) from the inner surface, and the edge partially defines a cavity.

10. The ventilation device according to claim 1, and further comprising a sealing ring extending around the housing.

11. The ventilation device according to claim 4, wherein the second membrane is annular, and wherein the first membrane is arranged in the centre of the second membrane.

12. The ventilation device according to claim 4, wherein the first membrane is made of Polyethylene terephthalate (PET) or Polytetrafluoroethylene (PTFE) material.

13. The ventilation device according to claim 4, wherein the second membrane is made of elastomer or thermoplastic elastomer.

14. The ventilation device according to claim 1, wherein a sensor is arranged within a cavity of the ventilation device, and wherein the sensor is at least one of a gas sensor, a humidity sensor, a pressure sensor and/or a temperature sensor.

15. Battery system comprising:
a battery casing with a vent opening and
a ventilation device located in the vent opening and comprising:
a housing adapted to be attached to the battery casing,
a cap with an outer surface and an inner surface, wherein the inner surface faces the housing, and the cap cooperates with the housing and extends above the housing,
a first membrane breathable and adapted to ensure pressure balance between the inside of the casing and its environment during normal operation conditions of the battery system, and
a second membrane having a first edge press-fitted between the housing and the cap and a second edge free to lift between the cap and the housing and operable as a check valve to provide emergency venting in case of technical defect within the battery system.

16. The battery system according to claim 15, wherein the first membrane is made of Polyethylene terephthalate (PET) or Polytetrafluoroethylene (PTFE) material, and the second membrane is made of elastomer or thermoplastic elastomer material.

17. The battery system according to claim 16, wherein the cap includes a central portion covered by the first membrane and an outer annular portion partly covered by the second membrane.

18. The battery system according to claim 17, wherein the first membrane covers the central portion and the outer annular portion.

19. The battery system according to claim 18, wherein the second membrane comprises an annular shape with an inner periphery and an outer periphery, and the outer periphery is closer from the cap than the inner periphery.

20. A ventilator for a battery system including a battery casing having a battery vent opening that defines an axis extending upward from inside the battery casing through the ventilator, and wherein the ventilator comprises:
a housing installable in the battery vent opening and partially defining a housing vent opening axially through the housing;
a cap located axially upward of and in contact with the housing and includes a central portion and an outward annular portion radially surrounding the central portion, and the central portion partially defines a cap vent opening axially through the cap;
a first membrane breathable and made of Polyethylene Terephthalate (PET) or Polytetrafluoroethylene (PTFE) material, fixed to the cap, and adapted to allow pressure between the inside of the casing and outside the casing to equalize via the cap vent opening of the central portion and through the first membrane during normal operation conditions of the battery system; and
a second membrane made of elastomer or thermoplastic elastomer material, and located axially between the cap and the housing and radially outward of the cap's central portion and axially upward of the first vent opening of the housing, and having a frustoconical shape with an inner periphery distal to the cap and an outer periphery proximal to the cap, and wherein the inner periphery is pressed and fixed between the housing and the cap while the outer periphery is free to lift axially upward between the cap and the housing and thereby, in case of technical defect within the battery system, operable as a check valve to provide emergency venting from the battery casing via the first vent opening.
